(19) United States
(12) Patent Application Publication
(10) Pub. No.: US 2016/0353280 A1
(43) Pub. Date: Dec. 1, 2016

(54) REAL-TIME DEVICE MONITORING AND ANALYSIS

(71) Applicant: TYMPHANY HK LIMITED, Wanchai (HK)

(72) Inventors: Kwok Shun Leung, Chai Wan (HK); Jacob Jan Szot, Shenzhen (CN)

(21) Appl. No.: 15/166,320

(22) Filed: May 27, 2016

Related U.S. Application Data
(60) Provisional application No. 62/167,948, filed on May 29, 2015.

(51) Int. Cl. H04W 12/06; G06F 3/0484; H04W 12/04; H04L 29/06; H04L 9/14

(52) U.S. Cl. CPC H04W 12/06; H04L 63/08; H04L 63/06; H04L 9/14; H04W 12/04; H04L 63/0428; G06F 3/0484; H04L 2209/80

(57) ABSTRACT

An aspect includes receiving, at a computer processor, encrypted data indicating operating characteristics of a wireless communication-enabled device. An aspect also includes decrypting the encrypted data received from the device, formatting the decrypted data into a predefined format, and displaying the formatted data in near real time via a graphical user interface of a website of an entity.

### BACKGROUND

The invention relates generally to device monitoring and analysis, and more specifically, to real-time monitoring and analysis of device operating characteristics and usage data.

### SUMMARY

According to an embodiment, a method for device monitoring and analysis is provided. The method includes receiving, at a computer processor, encrypted data indicating operating characteristics of a wireless communication-enabled device. The method also includes decrypting the encrypted data received from the device, formatting the decrypted data into a predefined format, and displaying the formatted data in near real time via a graphical user interface of a website of an entity.

According to another embodiment, a system for device monitoring and analysis is provided. The system includes a memory having computer readable instructions, and a processor for executing the computer readable instructions. The computer readable instructions include receiving encrypted data indicating operating characteristics of a wireless communication-enabled device, decrypting the encrypted data received from the device, formatting the decrypted data into a predefined format, and displaying the formatted data in near real time via a graphical user interface of a website of an entity.

According to a further embodiment, a computer program product for device monitoring and analysis is provided. The computer program product includes a computer readable storage medium having program instructions embodied therewith. The program instructions are executable by a computer processor to cause the computer processor to perform a method. The method includes receiving encrypted data indicating operating characteristics of a wireless communication-enabled device, decrypting the encrypted data received from the device, formatting the decrypted data into a predefined format, and displaying the formatted data in near real time via a graphical user interface of a website of an entity.

Additional features and advantages are realized through the techniques of the invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings, which:

FIG. 1 depicts a block diagram of a high-level system upon which real time device monitoring and analysis may be implemented in accordance with an embodiment of the invention;

FIG. 2 depicts a flow diagram illustrating a high-level process for implementing real time device monitoring and analysis in accordance with an embodiment of the invention;

FIG. 3 depicts a sample report generated by the real time device monitoring and analysis processes in accordance with an embodiment of the invention;

FIG. 4 depicts a diagram of a detailed architecture for implementing the real time device monitoring and analysis system in accordance with an embodiment of the invention; and

FIG. 5 depicts a database structure including sample data collected by the real time device monitoring and analysis processes in accordance with an embodiment of the invention.

### DETAILED DESCRIPTION

Exemplary embodiments provide real-time monitoring and analysis of device characteristics and usage data (also referred to herein as “device monitoring and analysis”). The embodiments further provide collection of the device characteristics and usage data, search capabilities of the collected and analyzed data, as well as reporting capabilities as will be described further herein. In an embodiment, the devices may be registered by the device monitoring and analysis before data is able to be collected therefrom. The devices may be any wireless communication-enabled products. For purposes of illustration, the devices described herein relate to audio devices and systems.

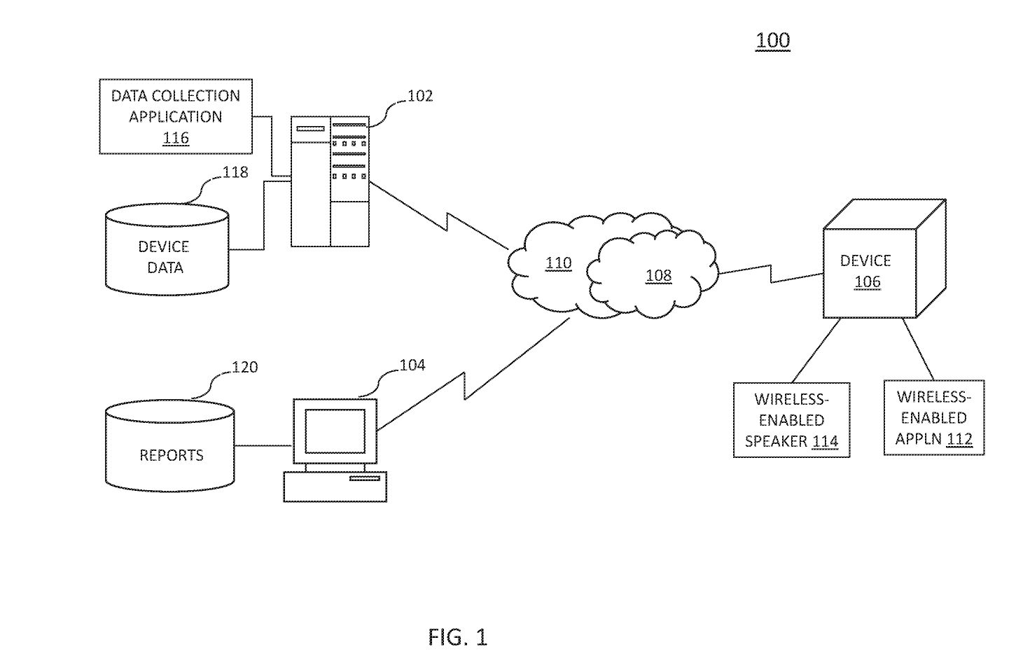

Turning now to FIG. 1, a system 100 upon which the device monitoring and analysis may be implemented will now be described in an embodiment. The system 100 includes a host system computer 102, a client system 104, and a device 106, each of which is communicatively coupled to one or more networks 108/110. The host system computer 102 may be implemented as a high-speed computer processing device for handling the volume of activities associated with end users of the device monitoring and analysis. In an embodiment, the host system computer 102 may be operated by an entity, such as an enterprise or organization that provides the device monitoring and analysis as a service to individual consumers and/or businesses. In a non-limiting embodiment, the host system computer 102 collects data from devices, such as a device 106.

It will be understood by those skilled in the art, that multiple host computers may be used in implementing the device monitoring and analysis and may be a function of the number of devices to be monitored, as well as the amount of data to be collected regardless of the number of devices monitored. With the potential of many devices being monitored, in an exemplary embodiment, the data collection may be implemented by a number of resources operating in a cloud computing environment. In this embodiment, the data collection may not be performed by the entity offering the device monitoring and analysis as a service, but rather by the data center which operates independently of the host system computer 102 and provides the data collection as a service to the host system computer 102.

For ease of illustration, the device monitoring and analysis processes are described herein as being implemented by the host system computer 102, i.e., absent any intervening data center. In this embodiment, the host system computer 102 executes a data collection application 116 for collecting and analyzing the device data.

The host system computer 102 may be coupled to a storage device 118 that stores the collected data, as well as results of the data analysis. The storage device 118 may be implemented using a variety of devices for storing electronic information. It is understood that the storage device 118 may be implemented using memory contained in the host system computer 102 or it may be a separate physical device, as illustrated in FIG. 1. The storage device 118 may be logically addressable as a consolidated data source across a distributed environment that includes one or ore networks, such as networks 108 and 110. Information stored in the storage device 118 is retrieved and manipulated via the host system computer 102.

The storage device 118 may store applications associated with the entity (e.g., enterprise applications), as well as the collected and analyzed device data. Storage device 118 may store an authentication scheme, such as key pairs used to authenticate devices from which data collection is implemented. The storage device 118 may also store account information for accounts that have been established for end users of the device monitoring and analysis. For example, a manufacturer entity of a brand of audio device may desire operating and usage data associated with its devices that are in use by consumers. In an embodiment, this manufacturer may establish an account with the host system computer 102 service and receive access to this type of data.

In an embodiment, the entity of the host system computer 102 hosts a website through which registration and account generation of end user may be implemented. The website may also be configured for searches of the data, as well as report generation, as will be described further herein. The website may be accessed through one or both of networks 108 and 110.

Client system 104 is operated by an end user of the device monitoring and analysis, such as a manufacturer and/or seller of device for which data is being collected. In an alternative embodiment, a client system may be operated by a consumer (one who purchased) of the device who is interested in acquiring the data collected and analyzed through the device monitoring and analysis. In a non-limiting embodiment, the client system 104 may be implemented through as general-purpose computer, laptop, or mobile device. The client system 104 may include a web browser application or extension in order to access the website of the host system computer 102. The client system 104 may store reports generated by the device monitoring and analysis in its storage 120, which may be implemented as internal memory.

The device 106 may be any type of wireless communication-enabled device that performs some specified, configured function. In a non-limiting embodiment, the device 106 is an audio device. Examples of audio devices include, but are not limited to, streaming music devices/systems, home and commercial theatre systems, and public announcement systems. The device 106 includes at least one wireless communication-enabled speaker 114, as well as a wireless communication-enabled application 112. The device 106 further includes a processor and memory (not shown). The processor executes the application 112 according to operating characteristics and usage of the speaker 114. In one embodiment, the application 112 may be configured to monitor characteristics such as battery usage with respect to the device 106. In addition, the memory of the device 106 may be configured to store a key pair that uniquely identifies the device 106 to the host system computer 102.

In an embodiment, network 108 refers to a short-range wireless network, while network 106 may be a combination of one or more different types of networks (e.g., local area network, wide area network, Internet, satellite, or terrestrial network, to name a few). In an embodiment, the network 106 may be implemented using various standard communication protocols, such as BLUETOOTH™ and/or WI-FI™. In an embodiment, the authentication process between the host system computer 102 and the device 106 is implemented through a local area network (e.g., one of networks 110) associated with the device.

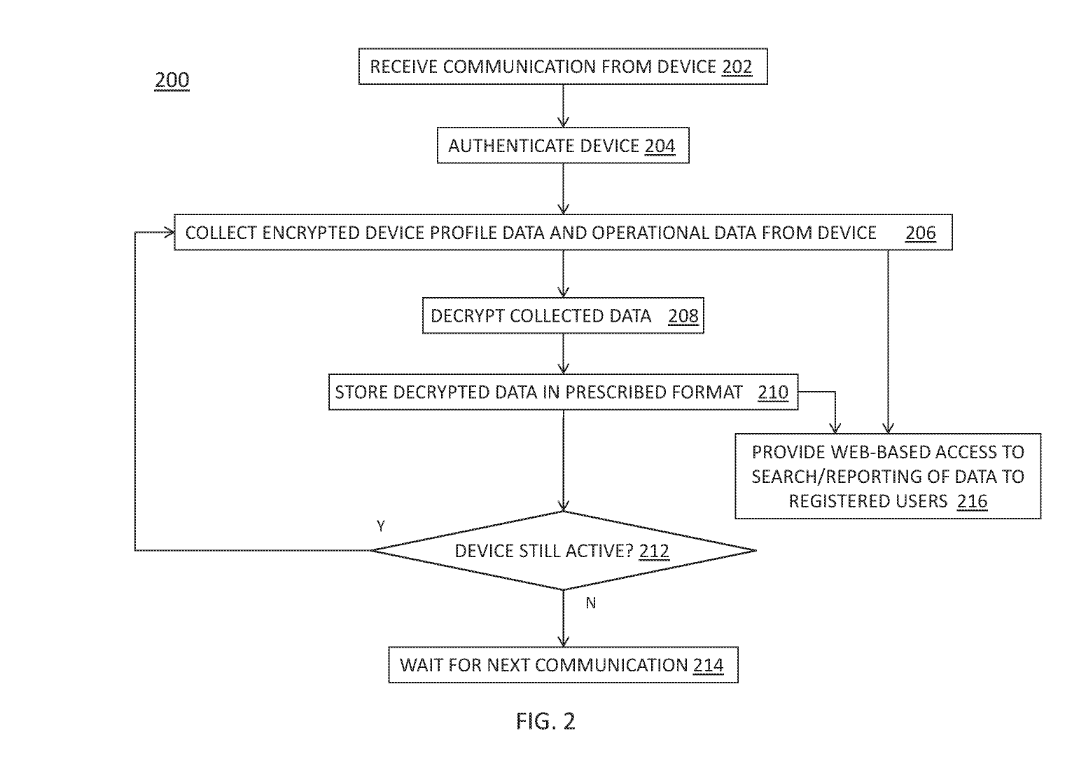

Turning now to FIG. 2, a flow diagram of a process for implementing the device monitoring and analysis will now be described in an embodiment. The process 200 of FIG. 2 assumes that a consumer of the device 106 has opted in to the data collection process. In an embodiment, the consumer may be prompted by the host system computer 102, e.g., through its website to opt in.

In block 202, the host system computer 102 receives a communication from the device 106 through networks 108/110. The communication may include device identification information, such as UID, MIN, IMEI, MEID, MAC address, etc. In this embodiment, the host system computer 102 may identify the device 106 through this address. In addition, if the device 106 is enabled with GPS, the application may track the device's location throughout a geographic location through GPS coordinates.

In block 204, the host system computer 102 authenticates the device 106 using a key pair established when the consumer agreed to participate in the data collection. In an embodiment, the host system computer 102 queries the device 106 for its key and uses this information in conjunction with the device identifier to authenticate the device 106.

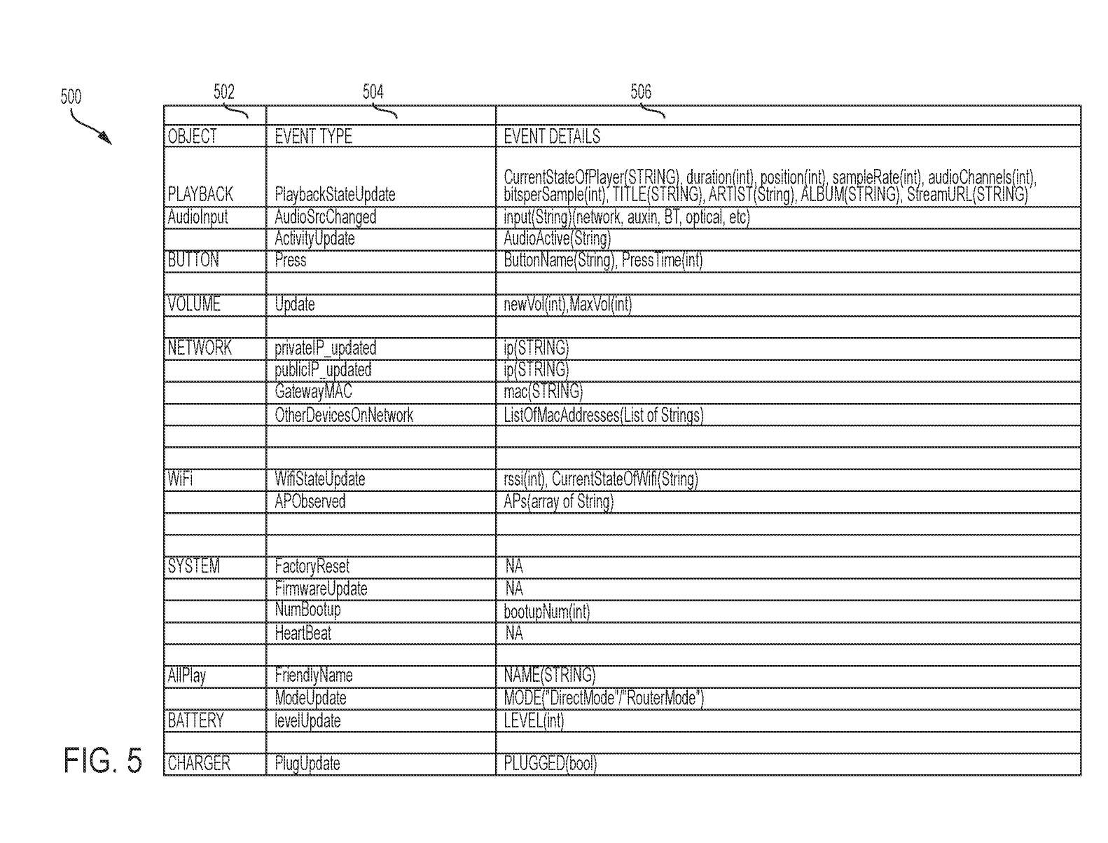

In block 206, operational characteristics and usage data is collected from the device 106 by the host system computer 102 through the networks 108/110. In an embodiment, the data is encrypted by the processor of the device 106 before it is transmitted over the networks 108/110 to the host system computer 102. A data structure 500 including sample data types that may be collected is shown in FIG. 5. In the data structure 500, a column 502 indicates the object of data collection, a column 504 indicates an event type, and column 506 indicates details of the event type.

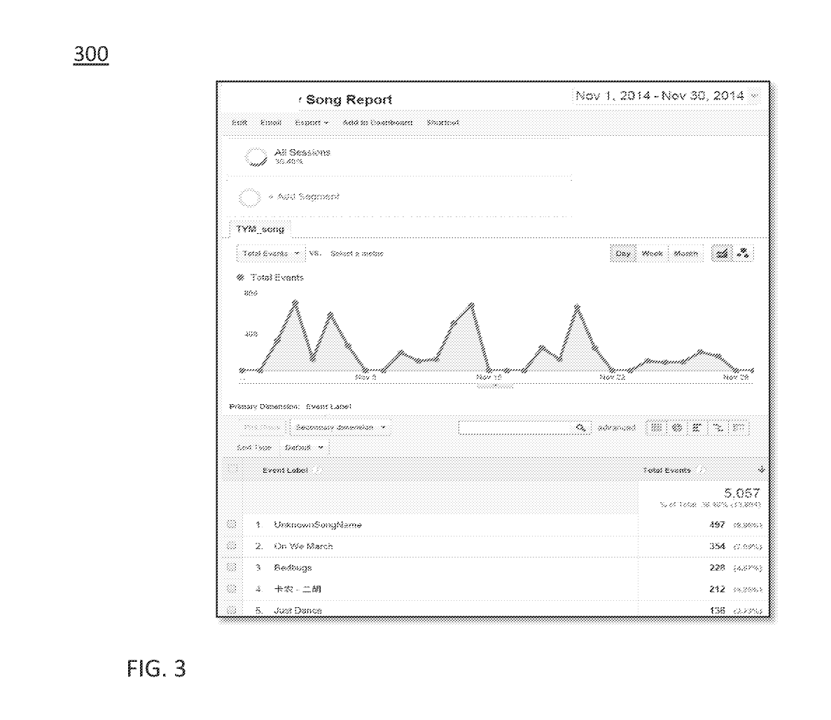

In block 208, the host system computer 102 decrypts the data received from the device 106 via the application 116. The decrypted data may be formatted, e.g., for searching and reporting functions. In an embodiment, the data that is collected may be viewable by end users in real time (or near real time) through a graphic user interface of the website of the host system computer 102 at block 216. In block 210, the decrypted formatted data is stored in the storage device 118. Once stored, the data is available for customized queries and report generation. A sample report 300 is shown in FIG. 3. In FIG. 3, the report 300 provides information for a plurality of sessions based on the monitoring. The sessions can be defined as a time frame in which certain monitoring activities are performed or can be defined by other metrics, which are configurable via the device monitoring and analysis processes. An event may refer to a subject of monitoring or other aspect of monitoring. As shown in FIG. 3, the event refers to songs played by the devices subject to monitoring. It is understood that other events are monitored as well and are described in FIG. 5. Primary and secondary dimensions may applied to further define information desired from the report.

Returning to FIG. 2, the host system computer 102 determines whether the device 106 is still active in block 212, e.g., the device is in operation and transmitting its data. If so, the process returns to block 206 in which the data continues to be collected. Otherwise, the application 116 stands by for the next communication, either from the same device 106 and/or from other devices subject to data collection in block 214.

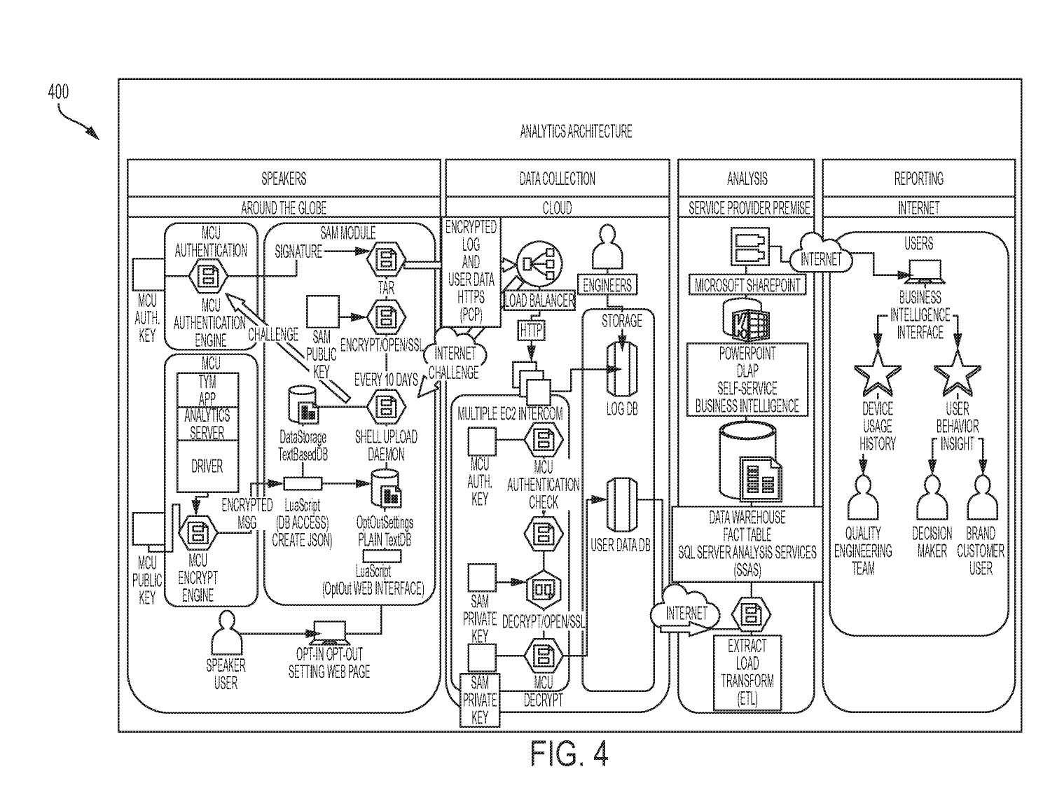

Turning now to FIG. 4, a diagram depicting an architecture for implementing the device monitoring and analysis will now be described in an embodiment. On the left side of the diagram 400, aspects and data flow associated with the device (speakers) are shown. This portion of the architecture illustrates the authentication process that is implemented between the device and the system collecting the data (shown in FIG. 4 as “Data Collection.” The next element of the architecture of 400 illustrates the analysis component of the architecture in which the collected data is processed. The final elements of the architecture 400 illustrates aspects and data flow associated with the reporting feature in which data corresponding to device and user behavior are used to generate custom reports based on feature selection.

The present invention may be a system, a method, and/or a computer program product. The computer program product may include a computer readable storage medium (or media) having computer readable program instructions thereon for causing a processor to carry out aspects of the present invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for device monitoring and analysis, comprising:
receiving, at a computer processor, encrypted data indicating operating characteristics of a wireless communication-enabled device;
decrypting the encrypted data received from the device;
formatting the decrypted data into a predefined format; and
displaying the formatted data in near real time via a graphical user interface of a website of an entity.

2. The method of claim 1, further comprising:
receiving a device identifier of the device; and
authenticating the device through an authentication scheme in conjunction with the device identifier.

3. The method of claim 1, wherein the device is an audio device and the operating characteristics include at least one of:
resource consumption and speed;
current operating state;
duration in operating state; and
event data.

4. The method of claim 3, wherein the event data includes at least one of:
song title;
artist; and
stream universal resource locator.

5. The method of claim 3, wherein the operating characteristics further include end user inputs to the device.

6. The method of claim 1 wherein the predefined format includes classifying the data according to at least one of: timestamp of data collection, device identifier, operating state of device, and events of data collected.

7. A system for device monitoring and analysis, the system comprising:
a memory having computer readable instructions; and
a processor for executing the computer readable instructions, the computer readable instructions including:
receiving encrypted data indicating operating characteristics of a wireless communication-enabled device;
decrypting the encrypted data received from the device;
formatting the decrypted data into a predefined format; and
displaying the formatted data in near real time via a graphical user interface of a website of an entity.

8. The system of claim 7, wherein the computer readable instructions further comprise further comprising:
receiving a device identifier of the device; and
authenticating the device through an authentication scheme in conjunction with the device identifier.

9. The system of claim 7, wherein the device is an audio device and the operating characteristics include at least one of:
resource consumption and speed;
current operating state;
duration in operating state; and
event data.

10. The system of claim 9, wherein the event data includes at least one of:
song title;
artist; and
stream universal resource locator.

11. The system of claim 9, wherein the operating characteristics further include end user inputs to the device.

12. The system of claim 7 wherein the predefined format includes classifying the data according to at least one of: timestamp of data collection, device identifier, operating state of device, and events of data collected.

13. A computer program product comprising a computer readable storage medium having program instructions embodied therewith, the program instructions executable by a computer processor to cause the computer processor to perform a method comprising:
receiving encrypted data indicating operating characteristics of a wireless communication-enabled device;
decrypting the encrypted data received from the device;
formatting the decrypted data into a predefined format; and
displaying the formatted data in near real time via a graphical user interface of a website of an entity.

14. The computer program product of claim 13, wherein the program instructions are further executable to provide:
receiving a device identifier of the device; and
authenticating the device through an authentication scheme in conjunction with the device identifier.

15. The computer program product of claim 13, wherein the device is an audio device and the operating characteristics include at least one of:
resource consumption and speed;
current operating state;
duration in operating state; and
event data.

16. The computer program product of claim 15, wherein the event data includes at least one of:
song title;
artist; and
stream universal resource locator.

17. The computer program product of claim 15, wherein the operating characteristics further include end user inputs to the device.

18. The computer program product of claim 13 wherein the predefined format includes classifying the data according to at least one of: timestamp of data collection, device identifier, operating state of device, and events of data collected.
